(19) United States
(12) Patent Application Publication
(10) Pub. No.: US 2007/0236930 A1
(43) Pub. Date: Oct. 11, 2007

(54) Vehicle lighting device

(75) Inventors: Hiroya Koizumi, Shizouka (JP); Yasuyuki Kato, Shizuoka (JP)

Correspondence Address: OSHA LIANG L.L.P., 1221 MCKINNEY STREET, SUITE 2800, HOUSTON, TX, 77010, US

(73) Assignee: KOITO MANUFACTURING CO., LTD., Tokyo (JP)

(21) Appl. No.: 11/786,322

(22) Filed: Apr. 11, 2007

(30) Foreign Application Priority Data
Apr. 11, 2006 (JP) 2006-108742

(51) Int. Cl. F21V 9/00

(52) U.S. Cl. 362/231

(57) ABSTRACT

A clearance lamp serving as a vehicle indicator lamp and a heterochromous lamp having a light source emitting light of a color different from a color of a light source of the clearance lamp are disposed adjacent to each other. A light source employing light emitting diodes, a reflector reflecting light emitted from the light source, and a diffusing lens transmitting and diffusing the light reflected by the reflector are disposed in the clearance lamp. At least a part of the reflector of the clearance lamp is formed as an upright wall portion serving as an interface with the heterochromous lamp.

### BACKGROUND OF INVENTION

1. Field of the Invention

The present invention relates to a vehicle lighting device, and more particularly, to a technique for simplifying a structure by allowing at least a part of a reflector of a clearance lamp to serve as an upright wall, which is an interface with a heterochromous lamp.

2. Background Art

A vehicle lighting device such as a vehicle headlamp in which a light source is disposed in a lamp chamber defined by a lens and a lamp body is known.

A so-called combination lamp including different types of lamps such as a head lamp, a turn signal lamp, and a clearance lamp, each of which has a light source, is known as such a vehicle lighting device (for example, see Patent Document 1).

The vehicle lighting device called a combination lamp has plural types of light sources. When the light sources emit light of different colors, upright walls serving as an interface between the lamps are required for preventing a problem due to interference of the light of different colors with each other.

In the past vehicle lighting device, for example, each lamp has a lamp body (or reflector) and an open face of each lamp body is covered with a lens, thereby forming a lamp space for each lamp. Accordingly, a part of the lamp body of each lamp serves as an upright wall, which is an interface with the adjacent lamp.

[Patent Document 1] Japanese Unexamined Patent Application Publication No. 2005-100739.

In the past vehicle lighting device, because the lamp bodies, corresponding to the number of lamps, are provided to be adjacent to each other, the structure is complex.

### SUMMARY OF INVENTION

Because the clearance lamp serves as an indicator lamp for notifying existence of the vehicle to the peripheries, the clearance lamp preferably has a wide visible angle.

One or more embodiments of the invention provide a vehicle lighting device with a simplified structure and a wide visible angle of a clearance lamp.

In accordance with one or more embodiments, a vehicle lighting device comprises a clearance lamp serving as a vehicle indicator lamp and a heterochromous lamp having a light source emitting light of a color different from a color of a light source of the clearance lamp are disposed adjacent to each other, a light source employing a light emitting diode, a reflector reflecting light emitted from the light source, and a diffusing lens transmitting and diffusing the light reflected by the reflector are disposed in the clearance lamp, and at least a part of the reflector of the clearance lamp is formed as an upright wall portion serving as an interface with the heterochromous lamp.

Accordingly, according to the vehicle lighting device of one or more embodiments of the invention, an interference of light emitted from the respective light sources of the clearance lamp and the heterochromous lamp is prevented by the reflector and the light emitted from the clearance lamp is allowed to travel in a state where the light is diffused by the diffusing lens.

According to one or more embodiments of the invention, there is provided a vehicle lighting device including a clearance lamp serving as a vehicle indicator lamp and a heterochromous lamp having a light source emitting light of a color different from a color of a light source of the clearance lamp, in which the clearance lamp and the heterochromous lamp are disposed adjacent to each other, wherein the clearance lamp includes a light source employing a light emitting diode, a reflector reflecting light emitted from the light source, and a diffusing lens transmitting and diffusing the light reflected by the reflector, and wherein at least a part of the reflector of the clearance lamp is formed as an upright wall portion serving as an interface with the heterochromous lamp.

Accordingly, because the light emitted from the light emitting diode is diffused by the diffusing lens and then is allowed to travel, it is possible to secure a wide visible angle.

According to one or more embodiments of the invention, the clearance lamp and the heterochromous lamp may share a lamp body together, a first lamp chamber for the heterochromous lamp and a second lamp chamber for the clearance lamp may be defined by the reflector independent of the lamp body, and the entire surface of the reflector may be subject to metal evaporation. Accordingly, by performing metal evaporation to the entire surface of the reflector, the reflector can be used as a member serving to reflect both the light emitted from the light source of the heterochromous lamp and the light emitted from the light source of the clearance lamp.

According to one or more embodiments of the invention, the light emitted from the light source of the clearance lamp may be reflected by the reflector and an optical axis from the light source of the clearance lamp to the reflector and an optical axis extending from the reflector to the diffusing lens may be substantially perpendicular to each other. Accordingly, it is possible to enhance the degree of freedom in design due to enhancement of the degree of freedom in arrangement position of the light source of the clearance lamp.

According to one or more embodiments of the invention, steps allowing the light emitted from the light source of the heterochromous lamp to travel in a direction tilted about the optical axis of the light source may be formed in the reflector. Accordingly, it is possible to easily shape the steps for widening the visible angle of the heterochromous lamp.

Other aspects and advantages of the invention will be apparent from the following description and the appended claims.

### BRIEF DESCRIPTION OF DRAWINGS

FIG. 1 shows a best mode for carrying out the invention along with FIGS. 2 to 4, where FIG. 1 is a schematic front view illustrating a vehicle lighting device.

FIG. 2 is an enlarged sectional view taken along line II-II of FIG. 1.

FIG. 3 is an enlarged sectional view taken along line III-III of FIG. 1.

FIG. 4 is an enlarged perspective view illustrating a reflector and a light emitting diode.

### DETAILED DESCRIPTION

Hereinafter, specific embodiments of a vehicle lighting device according to the invention will be described with reference to the accompanying drawings.

In one or more embodiments described below, the vehicle lighting device of the invention is applied to a vehicle lighting device called a so-called combination lamp including a head lamp, a turn signal lamp, and a clearance lamp. The invention is not limited to the vehicle lighting device, but can be applied widely to any combination lamps having a clearance lamp.

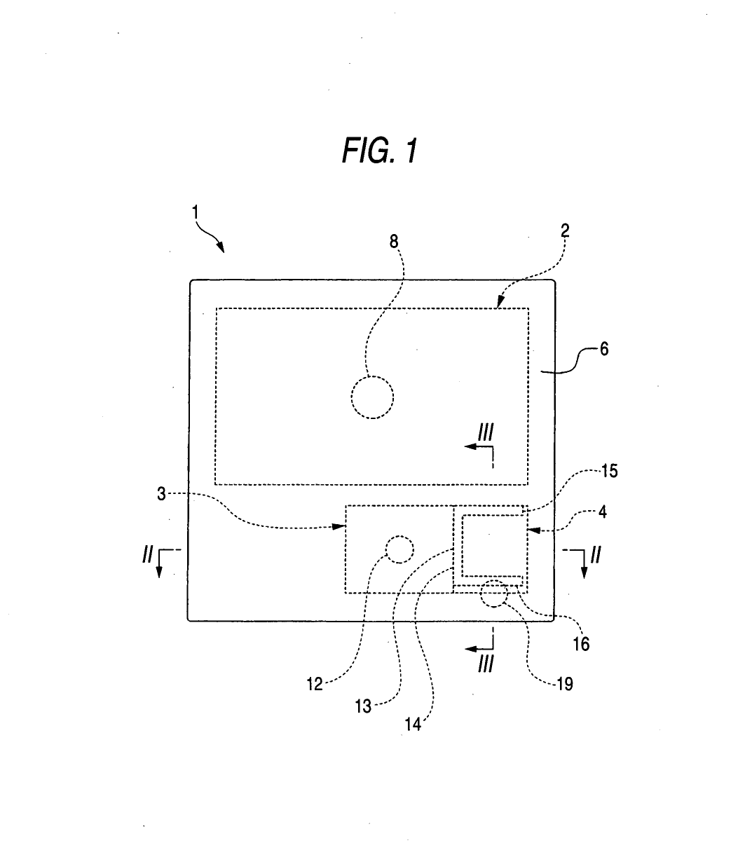

The vehicle lighting device 1 is disposed on right front end of a vehicle and is called a so-called combination lamp including a head lamp 2, a turn signal lamp 3, and a clearance lamp 4, as shown in FIG. 1. The head lamp 2 is disposed in an upper side and the turn signal lamp 3 and the clearance lamp 4 are disposed below the head lamp 2.

As shown in FIG. 1, the vehicle lighting device 1 includes an outer lamp body 5 having a concave portion opened forward and an outer lens 6 covering the open face of the outer lamp body 5. An inner space thereof defined by the outer lamp body 5 and the outer lens 6 is formed as a lamp chamber 7. A head-lamp light source 8 disposed in the lamp chamber 7 is attached to the rear end of the outer lamp body 5 (see FIG. 1).

The turn signal lamp 3 is provided as a heterochromous lamp having a light source emitting light of a color different from the color of the light source of the clearance lamp 4.

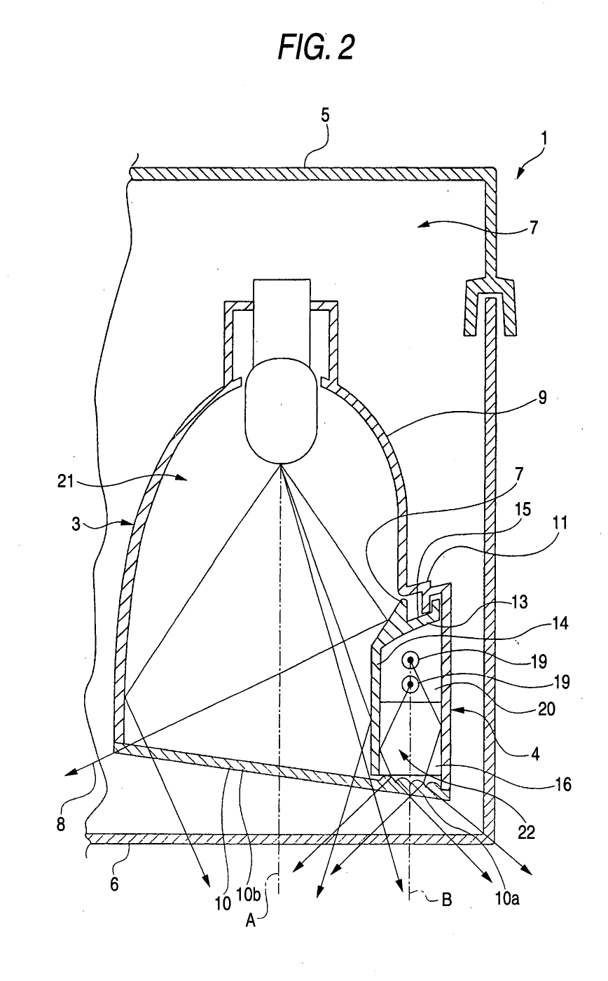

As shown in FIG. 2, the turn signal lamp 3 and the clearance lamp 4 are disposed in the lamp chamber 7. The turn signal lamp 3 and the clearance lamp 4 include a common inner lamp body 9 opened forward and a common inner lens 10 covering the open face of the inner lamp body 9. The substantially entire inner surface of the inner lamp body 9 is subject to metal evaporation such as aluminum evaporation. Accordingly, the inner lamp body 9 has a function as a reflector reflecting the light emitted from the light sources of the turn signal lamp 3 and the clearance lamp 4.

The right end portion of the inner lamp body 9 is provided with a mount portion 11 extending substantially in the anteroposterior direction. The mount portion 11 is located substantially at the center in the anteroposterior direction of the inner lamp body 9. A mounting recess 11a opened forward is formed in the mount portion 11.

A light source 12 for the turn signal lamp is mounted on the rear end portion of the inner lamp body 9. For example, orange color light is emitted from the light source 12 for the turn signal lamp.

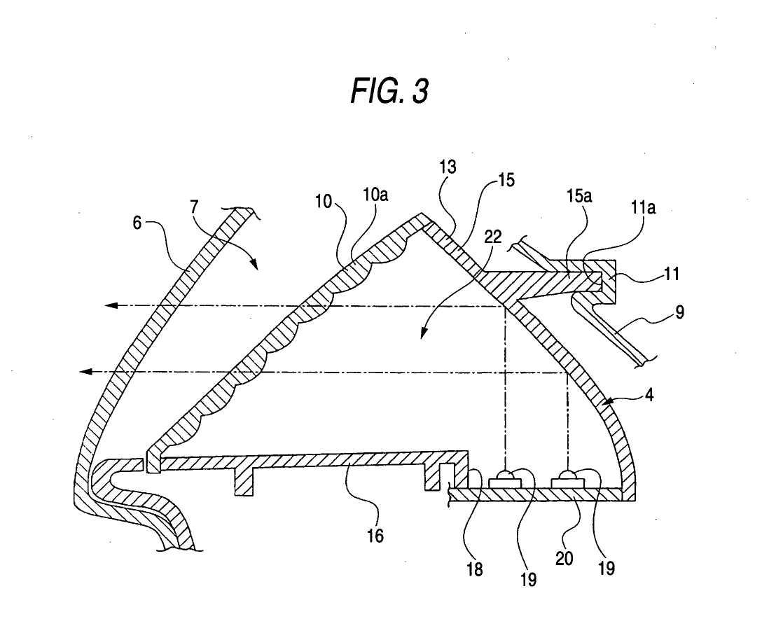

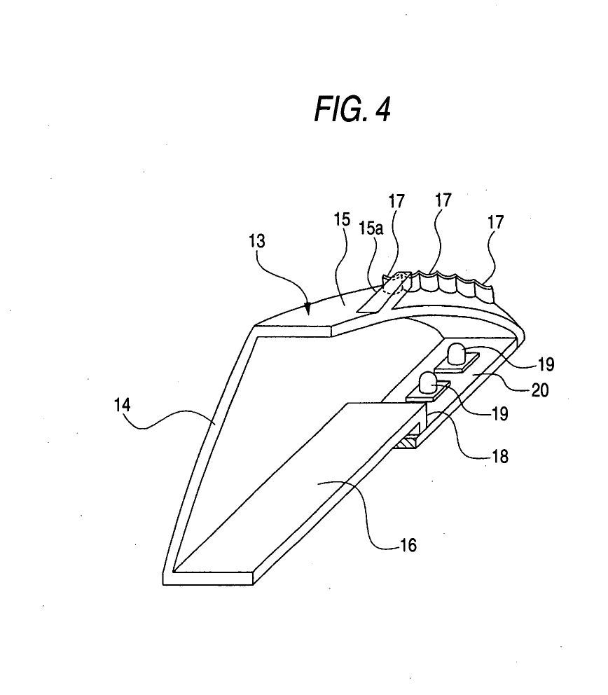

A reflector 13 is mounted on the mount portion 11 of the inner lamp body 9. As shown in FIGS. 3 and 4, the reflector 13 includes an upright wall portion 14 having a substantially triangular shape extending in the horizontal direction and deflected upward, a shading portion 15 protruding to right from the upper edge of the rear half of the upright wall 14, and a bottom portion 16 protruding to right from the lower edge of the upright wall portion 14, which all form a body.

The shading portion 15 is inclined so as to be displaced upward as it goes forward. Steps 17, 17, . . . protruding upward are formed in the left edge of the rear end portion of the shading portion 15. The left surfaces of the steps 17, 17, . . . are formed as a reflecting surface and the steps have a function of reflecting the light emitted from the light source 12 for the turn signal lamp and guiding the reflected light in a predetermined direction.

The shading portion 15 is provided with a fitting protrusion 15a protruding backward.

The bottom portion 16 protrudes from a portion other than the rear end portion in the lower edge of the upright wall portion 14. A space between the rear end of the bottom portion 16 and the rear end of the shading portion 15 is formed as a board mounting portion 18.

The entire surface of the reflector 13 is subject to metal evaporation such as aluminum evaporation.

The reflector 13 is mounted on the inner lamp body 9 by inserting the fitting protrusion 15a into a fitting recess 11a formed in the mounting portion 11 of the inner lamp body 9 (see FIG. 3).

A light-source board 20 mounted with light emitting diodes (LED) 19 and 19 are disposed in the board mounting portion 18 formed in the back of the bottom portion 16 (see FIGS. 3 and 4). The light emitting diodes 19 and 19 are located below the top surface of the bottom portion 16 and are not visible from the front side. The light emitting diodes 19 and 19 serve as a light source for the clearance lamp 4. Light of a color such as a white color different from the color of light emitted from the light source 12 for the turn signal lamp is emitted from the light emitting diodes 19 and 19.

The right end portion of the inner lens 10 is formed as a diffusing lens portion 10a. Diffusing steps such as fish-eye steps are formed on the inner surface of the diffusing lens portion 10a. The portion of the inner lens 10 other than the diffusing lens portion 10a is formed as a transparent lens portion 10b in which the diffusing steps are not formed.

In the state where the reflector 13 is mounted on the inner lamp body 9, the upright wall portion 14 of the reflector 13 serves as a partition portion for partitioning the inner space defined by the inner lamp body 9 and the inner lens 10 in the horizontal direction. Accordingly, the inner space defined by the inner lamp body 9 and the inner lens 10 is partitioned into a first lamp chamber 21 and a second lamp chamber 22 by the upright wall portion 14 of the reflector 13 and thus the turn signal lamp 3 having the first lamp chamber 21 and the clearance lamp 4 having the second lamp chamber 22 are isolated from each other.

The first lamp chamber 21 has a space surrounded with the portion of the inner lamp body 9 other than the right end portion, the reflector 13, and the transparent lens portion 10b of the inner lens 10 and the second lamp chamber 22 has a space surrounded with the right end portion of the inner lamp body 9, the reflector 13, and the diffusing lens portion 10a of the inner lens 10 (see FIG. 2).

In the vehicle lighting device 1 having the above-mentioned configuration, when light is emitted from the light source 8 for the head lamp, the emitted light passes through the outer lens 6 and travels forward.

When the orange color light is emitted from the light source 12 for the turn signal lamp, the emitted light passes through the transparent lens portion 10b of the inner lens 10 and the outer lens 6 and travels forward. At this time, a part of the light emitted from the light source 12 for the turn signal lamp is reflected by the inner surface of the inner lamp body 9 and the left side surface of the upright wall portion 14 of the reflector 13 and travels at a predetermined angle about the optical axis A (see FIG. 2).

At the same time, the other part of the light emitted from the light source 12 for the turn signal lamp is reflected by the steps 17, 17, . . . of the reflector 13. The light reflected by the steps 17, 17, . . . travels at a large angle about the optical axis A, as indicated by arrow S in FIG. 2.

When the white light is emitted from the light emitting diodes 19 and 19, the emitted light passes through the diffusing lens portion 10a of the inner lens and the outer lens 6 and then travels forward. At this time, the light emitted upward from the light emitting diodes 19 and 19 is reflected by the shading portion 15 of the reflector 13 and then travels forward in the perpendicular direction (see FIG. 3).

A part of the light emitted from the light emitting diodes 19 and 19 is reflected by the inner surface of the inner lamp body 9 and the right side surface of the upright wall portion 14 of the reflector 13, is diffused by the diffusing lens portion 10a, and then travels at a predetermined angle about the optical axis B (see FIG. 2).

As described above, the light emitted from the light source 12 for the turn signal lamp is reflected by the left side surface of the upright wall portion 14 and the light emitted from the light emitting diodes 19 and 19 is reflected by the right side surface of the upright wall portion 14. Accordingly, the light emitted from the light source 12 for the turn signal lamp and the light emitted from the light emitting diodes 19 and 19 are prevented from interfering with each other.

As described above, in the vehicle lighting device 1, because the diffusing lens portion 10a is formed in the inner lens 10 of the clearance lamp 4, the light emitted from the light emitting diodes 19 and 19 is diffused by the diffusing lens portion 10a, and a wide visible angle is obtained.

The turn signal lamp 3 and the clearance lamp 4 are isolated from each other by disposing the reflector 13 in the inner space defined by the inner lamp body 9 and the inner lens 10 and thus the light emitted from the light source 12 for the turn signal lamp and the light emitted from the light emitting diodes 19 and 19 are prevented from interfering with each other. Accordingly, it is possible to simplify the structure of the vehicle lighting device 1.

The vehicle lighting device 1 is provided with the reflector 13 independent of the inner lamp body 9 and the entire surface of the reflector 13 is subject to metal evaporation. Since the reflector 13 is independent of other members, the metal evaporation can be easily carried out. By performing the metal evaporation to the entire surface of the reflector 13, the reflector 13 can be used as a member reflecting both of the light emitted from the light source 12 for the turn signal lamp and the light emitted from the light emitting diodes 19 and 19.

In the vehicle lighting device 1, because the light emitted from the light emitting diodes 19 and 19 is reflected by the shading portion 15 of the reflector 13, it is possible to enhance the degree of freedom in design due to the enhancement of the degree of freedom in arrangement positions of the light emitting diodes 19 and 19. In addition, it is possible to enhance visual quality of the vehicle lighting device 1 by disposing the light emitting diodes 19 and 19 at the positions not visible from the outside of the outer lens 6.

In addition, in the vehicle lighting device 1, because the reflector 13, independent of the inner lamp body 9, is provided with the steps 17, 17, . . . for guiding the light emitted from the light source 12 for the turn signal lamp in a predetermined direction, it is easy to shape the steps 17, 17, . . . and it is possible to widen the visible angle of the turn signal lamp 3.

### DESCRIPTION OF REFERENCE NUMERALS

1: VEHICLE LAMP UNIT

3: TURN SIGNAL LAMP (HETEROCHROMOUS LAMP)

4: CLEARANCE LAMP

9: INNER LAMP BODY (LAMP BODY)

10a: DIFFUSING LENS PORTION (DIFFUSING LENS)

13: REFLECTOR

14: UPRIGHT WALL PORTION

17: STEP

19: LIGHT EMITTING DIODE

21: FIRST LAMP CHAMBER

22: SECOND LAMP CHAMBER

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A vehicle lighting device comprising:
a clearance lamp serving as a vehicle indicator lamp; and
a heterochromous lamp having a light source emitting light of a color different from a color of a light source of the clearance lamp,
wherein the clearance lamp and the heterochromous lamp are disposed adjacent to each other,
wherein the light source of the clearance lamp comprises a light emitting diode, a reflector reflecting light emitted from the light source, and a diffusing lens transmitting and diffusing the light reflected by the reflector, and
wherein at least a part of the reflector of the clearance lamp is formed as an upright wall portion serving as an interface with the heterochromous lamp.

2. The vehicle lighting device according to claim 1, wherein the clearance lamp and the heterochromous lamp are disposed within a lamp body,
wherein a first lamp chamber for the heterochromous lamp and a second lamp chamber for the clearance lamp are defined by the reflector independent of the lamp body, and
wherein an entire surface of the reflector is subject to metal evaporation.

3. The vehicle lighting device according to claim 1, wherein the light emitted from the light source of the clearance lamp is reflected by the reflector, and
wherein an optical axis from the light source of the clearance lamp to the reflector and an optical axis extending from the reflector to the diffusing lens are substantially perpendicular to each other.

4. The vehicle lighting device according to claim 1, wherein steps allowing the light emitted from the light source of the heterochromous lamp to travel in a direction tilted about the optical axis of the light source are formed in the reflector.

5. The vehicle lighting device according to claim 2, wherein the light emitted from the light source of the clearance lamp is reflected by the reflector, and
wherein an optical axis from the light source of the clearance lamp to the reflector and an optical axis extending from the reflector to the diffusing lens are substantially perpendicular to each other.

6. The vehicle lighting device according to claim 2, wherein steps allowing the light emitted from the light source of the heterochromous lamp to travel in a direction tilted about the optical axis of the light source are formed in the reflector.

7. The vehicle lighting device according to claim 3, wherein steps allowing the light emitted from the light source of the heterochromous lamp to travel in a direction tilted about the optical axis of the light source are formed in the reflector.

8. The vehicle lighting device according to claim 1, further comprising a lamp body configured to house the clearance lamp and the heterochromous lamp,
wherein the reflector defines a first lamp chamber within the lamp body for the heterochromous lamp and a second lamp chamber within the lamp body for the clearance lamp.

9. The vehicle lighting device according to claim 8, wherein first lamp chamber and the second lamp chamber are defined independent of a shape of the lamp body.

10. The vehicle lighting device according to claim 9, wherein the reflector comprises steps allowing the light emitted from the light source of the heterochromous lamp to travel in a direction tilted about the optical axis of the light source.

11. A method of manufacturing a vehicle lighting device comprising a clearance lamp serving as a vehicle indicator lamp; and a heterochromous lamp having a light source emitting light of a color different from a color of a light source of the clearance lamp, wherein the light source of the clearance lamp comprises a light emitting diode, a reflector reflecting light emitted from the light source, and a diffusing lens transmitting and diffusing the light reflected by the reflector, the method comprising:
disposing the clearance lamp and the heterochromous lamp adjacent to each other, and
forming at least a part of the reflector of the clearance lamp as an upright wall portion serving as an interface with the heterochromous lamp.

12. The method of manufacturing a vehicle lighting device of claim 11, further comprising disposing the clearance lamp and the heterochromous lamp within a lamp body,
wherein a first lamp chamber for the heterochromous lamp and a second lamp chamber for the clearance lamp are defined by the reflector independent of the lamp body.

13. The method of manufacturing a vehicle lighting device of claim 11, further comprising subjecting an entire surface of the reflector to metal evaporation.

14. The method of manufacturing a vehicle lighting device of claim 11, further comprising forming steps allowing the light emitted from the light source of the heterochromous lamp to travel in a direction tilted about the optical axis of the light source in the reflector.

15. The method of manufacturing a vehicle lighting device of claim 11, further comprising
housing the clearance lamp and the heterochromous lamp in a lamp body,
defining, with the reflector, a first lamp chamber within the lamp body for the heterochromous lamp and a second lamp chamber within the lamp body for the clearance lamp.

16. The method of manufacturing a vehicle lighting device of claim 15, wherein the defining of the first lamp chamber and the second lamp chamber is independent of a shape of the lamp body.

17. The method of manufacturing a vehicle lighting device of claim 16, further comprising forming steps allowing the light emitted from the light source of the heterochromous lamp to travel in a direction tilted about the optical axis of the light source in the reflector.

18. The method of manufacturing a vehicle lighting device of claim 17, further comprising subjecting an entire surface of the reflector to metal evaporation.

19. The method of manufacturing a vehicle lighting device of claim 11, wherein the light emitted from the light source of the clearance lamp is reflected by the reflector, and
wherein an optical axis from the light source of the clearance lamp to the reflector and an optical axis extending from the reflector to the diffusing lens are substantially perpendicular to each other.
